(19) United States
(12) Patent Application Publication
(10) Pub. No.: US 2003/0023484 A1
(43) Pub. Date: Jan. 30, 2003

(54) Ring laser gyroscope having combined electrode and getter

(76) Inventor: Dhirubhai Patel, West Hills, CA (US)

Correspondence Address: John H. Lynn, Suite F200, 2915 Redhill Avenue, Costa Mesa, CA, 92626, US

(21) Appl. No.: 09/916,612

(22) Filed: Jul. 27, 2001

(51) Int. Cl. H01J 19/70

(52) U.S. Cl. 705/14

(57) ABSTRACT

An electrode and getter structure for a ring laser gyroscope that includes a frame having a cavity therein that contains a gain medium and an electrode bore extending from a surface of the frame to the cavity includes a metalization layer formed on the surface of the frame. The metalization layer includes an electrode that is adjacent the electrode bore. A getter well is sealed to the metalization layer around the electrode bore, and a getter is mounted in the getter well spaced apart from the frame. The getter well preferably is a hollow glass cylinder having a closed end and an open end mounted to the metalization layer. A spring preferably is retained in the getter well by elastic forces in the spring with the getter being attached to the spring and aligned with the electrode bore.

### BACKGROUND OF THE INVENTION

This invention relates generally to ring laser gyroscopes and particularly to a combined electrode and getter structure for ring laser gyroscopes.

### SUMMARY OF THE INVENTION

This invention is directed to an electrode and getter structure for a gas discharge device such as a ring laser gyroscope that includes a frame having a cavity therein that contains a gain medium and an electrode bore extending from a surface of the frame to the cavity. The invention includes a metalization layer formed on the surface of the frame with the metalization layer including an electrode that is adjacent the electrode bore. A getter well is mounted to the frame around the electrode bore, and a getter is mounted in the getter well spaced apart from the frame.

The metalization layer preferably extends around the electrode bore with the getter well being sealed to the metalization layer.

The metalization layer preferably includes an electrical contact arranged so that an electrical signal may be applied to the electrode.

The getter well preferably comprises a hollow glass cylinder having a closed end and an open end mounted to the metalization layer. A spring preferably is retained in the getter well by elastic forces in the spring with the getter being attached to the spring and aligned with the electrode bore.

### BRIEF DESCRIPTION OF THE DRAWINGS

FIG. 1 is a top plan view of a ring laser gyroscope including a combined electrode and getter according to the invention;

FIG. 2 is a side elevation view of the apparatus of FIG. 1 with a portion removed to show an electrode structure that may be included in the present invention; and

FIG. 3 shows a getter mounted in a getter well in accordance with the present invention.

### DETAILED DESCRIPTION OF THE INVENTION

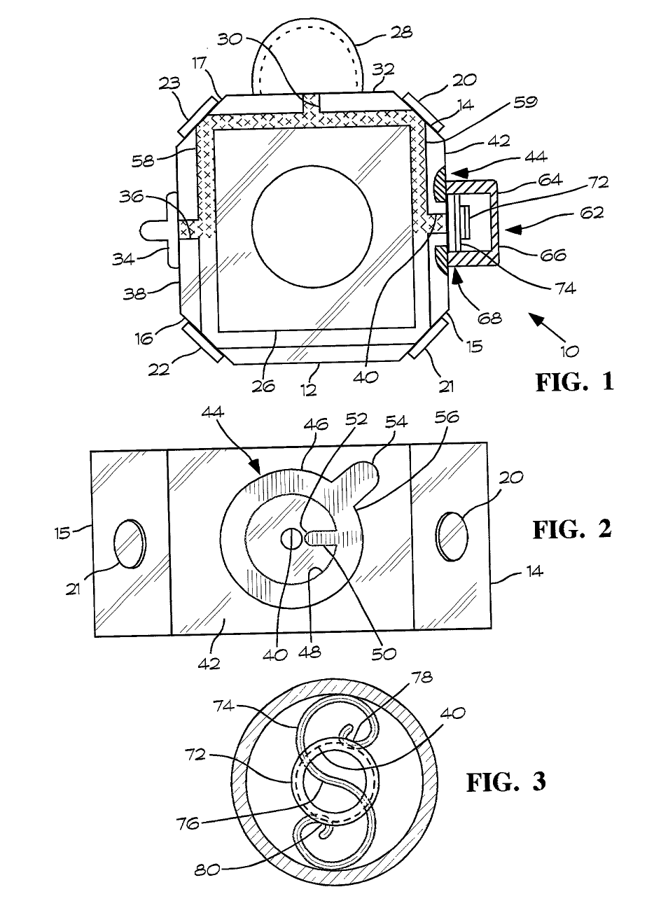

FIGS. 1 and 2 show a ring laser gyroscope 10 that includes a frame 12 that is preferably formed as a block of a glass ceramic material. Suitable materials and structures for the frame 12 are well known in the art and are not described further here except as necessary to describe the present invention. The ring laser gyroscope 10 is representative of a gas discharge device that includes the invention. Accordingly, it should be understood that invention is not limited in its application to ring laser gyroscopes, but instead may be practiced with any gas discharge device that includes a getter.

The frame 12 has four flat surfaces 14-17 where corresponding mirrors 20-23 are mounted. The frame 12 further includes a cavity 26 therein that forms a closed optical path that includes the mirrors 20-23. In a preferred embodiment of the invention, the optical path is a skewed rhombus. Other shapes such as rectangular and triangular are possible. An electrode 28 is mounted to the frame 12 adjacent an electrode bore 30 that extends from a side 32 of the frame to the cavity 26. An electrode 34 is mounted to the frame 12 adjacent an electrode bore 36 that extends from a side 38 of the frame to the cavity 26. In the ring laser gyroscope 10 the electrode 28 is a cathode and the electrode 34 is an anode, which may be conventional structures that are well known in the art.

As shown in FIGS. 1 and 2, the frame 12 includes an electrode bore 40 that extends from a side surface 42 of the frame to the cavity 26. A metalization layer 44 is formed on the side surface 42 of the frame 12 around the electrode bore 40. As shown in FIG. 2, the metalization layer 44 includes a ring 46 having an inner edge 48 that is spaced apart from the electrode bore 40. An inner projection 50 of the metalization layer 44 extends from the inner edge 48 to form an electrode 52 that is adjacent the electrode bore 40. In the ring laser gyroscope 10 the electrode 52 is a second anode.

Still referring to FIG. 2, an outer projection 54 extends from an outer portion 56 of the metalization layer 44. The outer projection 54 serves as a contact so that an electrical signal applied thereto will be conducted to the ring 46 and then to the electrode 52.

A gain medium that preferably comprises a mixture of helium and neon gases is sealed in the cavity 26 using techniques that are well known in the art. Application of suitable excitation voltages between the electrode 28 and the two electrodes 34 and 52 causes energy level transitions in the gain medium that produce counterpropagating coherent light beams in the cavity 26. The energy level transitions occur in the cavity 26 between the electrode 34 and the electrode 28 and between the electrode 52 and the electrode 28. The sum of the length of a portion 58 of the cavity 26 between the electrode 34 and the electrode 28 and a portion 59 between the electrode 52 and the electrode 28 defines a discharge length. The gain of the ring laser gyroscope 10 is directly related to the discharge length. The electrodes 34 and 52 are symmetrically located with respect to the electrode 28 so that the two portions of the gain medium where the lasing action occurs have the same length. The anode electrodes 34 and 52 in the ring laser gyroscope 10 can be made of very thin metal because they are bombarded by electrons of very little mass and momentum

A getter assembly 62 is mounted to the metalization layer 44. The getter assembly 62 preferably includes a hollow glass cylinder serving as a getter well 64 having a closed outer end 66 and an open inner end 68 arranged to enclose a getter 72. The metalization layer 44 is applied directly to the frame 12. The metalization layer 44 associated with this invention serves the dual purpose of being the solder seal metalization for the getter well 64 and the physical electrode 52 required for sustained discharge of the lasing medium.

As shown in FIGS. 1 and 3, the getter assembly 62 includes a getter 72 that is mounted in the getter well 64. The getter 72 may be formed as an annular ring comprised of a material that absorbs gasses in the cavity 26 that would extinguish the lasing action. Getter structures and materials are well known. The getter 64 is external to the frame 12 and is spaced apart from the side 42 in which the anode bore 40 is formed. A spring 74 may be used to mount the getter 72 in the getter well 64. The spring 74 may have a generally “S” shaped configuration arranged so that when it is compressed to fit in the getter well 64, the spring 74 has a central portion 76 and a pair of end portions 78 and 80 that support the generally annular ring-shaped getter 72. The getter 72 may be secured to the spring by spot welded wire (not shown) in a manner well known in the art.

The structures and methods disclosed herein illustrate the principles of the present invention. The invention may be embodied in other specific forms without departing from its spirit or essential characteristics. The described embodiments are to be considered in all respects as exemplary and illustrative rather than restrictive. Therefore, the appended claims rather than the foregoing description define the scope of the invention. All modifications to the embodiments described herein that come within the meaning and range of equivalence of the claims are embraced within the scope of the invention.

What is claimed is:

1. An electrode and getter structure for gas discharge device that includes a frame having a cavity therein that contains a gain medium and an electrode bore extending from a surface of the frame to the cavity, comprising:
a metalization layer formed on the surface of the frame, the metalization layer including an electrode that is adjacent the electrode bore;
a getter well mounted to the frame around the electrode bore; and
a getter mounted in the getter well spaced apart from the frame.

2. The electrode and getter structure of claim 1 wherein the metalization layer extends around the electrode bore and the getter well is sealed to the metalization layer.

3. The electrode and getter structure of claim 2 wherein the metalization layer includes an electrical contact arranged so that an electrical signal may be applied to the electrode.

4. The electrode and getter structure of claim 1 wherein the getter well comprises a hollow glass cylinder having a closed end and an open end mounted to the metalization layer.

5. The electrode and getter structure of claim 4 further comprising a spring retained in the getter well by elastic forces in the spring with the getter being attached to the spring and aligned with the electrode bore.

6. An electrode and getter structure for a gas discharge device that includes a frame having a cavity therein that contains a gain medium and an electrode bore extending from a surface of the frame to the cavity, comprising:
a metalization layer formed on the surface of the frame, the metalization layer including:
a ring that extends around the electrode bore and is spaced apart therefrom;
an electrode formed in the metalization layer to extend inward in the ring to a location adjacent the electrode bore; and
an electrical contact in the metalization layer and arranged to extend away from the ring;
a getter well sealed to the metalization layer;
a spring mounted in the getter well such that elastic forces in the spring retain it in a selected position; and
a getter mounted in the getter well spaced apart from the frame and aligned with the electrode bore.

7. A method for forming an electrode and getter structure for a gas discharge device that includes a frame having a cavity therein that contains a gain medium and an electrode bore extending from a surface of the frame to the cavity, comprising the steps of:
forming a metalization layer on the surface of the frame, the metalization layer being formed to include an electrode that is adjacent the electrode bore;
sealing a getter well to the frame around the electrode bore; and
mounting a getter in the getter well spaced apart from the frame.

8. The method of claim 7 including the steps of forming the metalization layer to extend around the electrode bore; and
securing the getter well is to the metalization layer.

9. The method of claim 8 including the step of forming the metalization layer to include an electrical contact arranged so that an electrical signal may be applied to the electrode.

10. The method of claim 7 including the step of forming the getter well to comprise a hollow glass cylinder having a closed end and an open end mounted to the metalization layer.

11. The method of claim 10 further comprising the steps of:
attaching the getter to a spring; and
mounting the spring in the getter well.

12. A method for forming a gas discharge device that includes a frame having a cavity therein that contains a gain medium and an electrode bore extending from a surface of the frame to the cavity, comprising:
forming a metalization layer as a ring that extends around the electrode bore and is spaced apart therefrom on the surface of the frame:
forming an electrode in the metalization layer that extends inward in the ring to a location adjacent the electrode bore; and
forming an electrical contact in the metalization layer extending away from the ring;
providing a getter well;
mounting a getter to a spring;
mounting the spring in the getter well that elastic forces in the spring retain it in a selected position; and
sealing the getter well to the metalization layer.
